(19) United States
(12) Patent Application Publication
(10) Pub. No.: US 2020/0298843 A1
(43) Pub. Date: Sep. 24, 2020

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Hideki Matsunaga, Wako-shi (JP); Kosuke Nakanishi, Wako-shi (JP); Takayasu Kumano, Wako-shi (JP); Umiaki Matsubara, Wako-shi (JP); Misa Komuro, Wako-shi (JP)

(21) Appl. No.: 16/820,793

(22) Filed: Mar. 17, 2020

(30) Foreign Application Priority Data
Mar. 19, 2019 (JP) 2019-051628

(51) Int. Cl. B60W 30/09; G05D 1/02; B60W 40/04; B60W 10/04; B60W 10/20

(52) U.S. Cl. CPC B60W 30/09; G05D 1/0214; B60W 40/04; G05D 2201/0213; B60W 10/20; G05D 2201/0212; B60W 10/04

(57) ABSTRACT

A vehicle control device includes: a recognizer configured to recognize a surrounding situation of an own vehicle; and a driving controller configured to perform at least one of speed control and steering control of the own vehicle based on the surrounding situation recognized by the recognizer. The driving controller causes the own vehicle to continuously travel forward when the recognizer recognizes that an obstacle and an oncoming vehicle are in a travel direction of the own vehicle and the recognizer recognizes that the oncoming vehicle is moving in a direction away from the own vehicle in a vehicle width direction.

### CROSS-REFERENCE TO RELATED APPLICATION

Priority is claimed on Japanese Patent Application No. 2019-051628, filed Mar. 19, 2019, the content of which is incorporated herein by reference.

### BACKGROUND

### Field of the Invention

The present invention relates to a vehicle control device, a vehicle control method, and a storage medium.

### Description of Related Art

In recent years, studies of automated vehicle control have been conducted. For example, a driving support technology for deriving a distance or the like between vehicles at the time of passing by and determining whether it is difficult to pass by when an oncoming vehicle is traveling is known. A driving support technology for waiting until an oncoming vehicle passes by a parked vehicle when there is a parked vehicle in front of an own vehicle and a driving support technology for passing a parked vehicle when an oncoming vehicle is decelerating are known (for example, see Japanese Unexamined Patent Application, First Publication No. 2018-106243, Japanese Unexamined Patent Application, First Publication No. 2005-182753, and Japanese Unexamined Patent Application, First Publication No. 2016-011030).

### SUMMARY

However, when a driver performs manual driving without depending on driving support in a situation in which a parked vehicle is in front and an oncoming vehicle is traveling, it is determined whether a driver of the oncoming vehicle gives way in consideration of various situations. When it is determined that the driver gives way, the vehicle travels beyond a center line and passes the parked vehicle. On the other hand, in studies of how vehicles are automatically controlled, control to which determination when a driver performs driving is added has not been sufficiently examined.

The present invention is devised in view of such circumstances and an objective of the present invention is to provide a vehicle control device, a vehicle control method, and a storage medium enabling passing by an oncoming vehicle during automated driving to be performed more smoothly.

A vehicle control device, a vehicle control method, and a storage medium according to the present invention adopt the following configurations.

(1) According to a first aspect of the present invention, a vehicle control device is provided including: a recognizer configured to recognize a surrounding situation of an own vehicle; and a driving controller configured to perform at least one of speed control and steering control of the own vehicle based on the surrounding situation recognized by the recognizer. The driving controller causes the own vehicle to continuously travel forward when the recognizer recognizes that an obstacle and an oncoming vehicle are in a travel direction of the own vehicle and the recognizer recognizes that the oncoming vehicle is moving in a direction away from the own vehicle in a vehicle width direction.

(2) In the vehicle control device according to the aspect (1), the driving controller may cause the own vehicle to travel forward so that the own vehicle enters the oncoming lane to avoid the obstacle when the recognizer recognizes that the obstacle and the oncoming vehicle are in the travel direction of the own vehicle and the recognizer recognizes that the oncoming vehicle is moving in the direction away from the own vehicle in the vehicle width direction.

(3) In the vehicle control device according to the aspect (1), the driving controller may cause the own vehicle to continuously travel forward when the recognizer recognizes that the obstacle and the oncoming vehicle are in the travel direction of the own vehicle, the recognizer recognizes that the oncoming vehicle is moving in the direction away from the own vehicle in the vehicle width direction, and the recognizer recognizes that the oncoming vehicle is decelerating.

(4) In the vehicle control device according to the aspect (1), the driving controller causes the own vehicle to continuously travel forward when the recognizer recognizes that the obstacle and the oncoming vehicle are in the travel direction of the own vehicle, the recognizer recognizes that the oncoming vehicle is moving in the direction away from the own vehicle in the vehicle width direction, and the recognizer recognizes that a driver of the oncoming vehicle recognizes the own vehicle.

(5) In the vehicle control device according to the aspect (1), the driving controller may cause the own vehicle to continuously travel forward when the recognizer recognizes that the obstacle and the oncoming vehicle are in the travel direction of the own vehicle, the recognizer recognizes that the oncoming vehicle is moving in the direction away from the own vehicle in the vehicle width direction, and the recognizer recognizes that the obstacle and another avoidance target are not near the oncoming vehicle.

(6) In the vehicle control device according to the aspect (1), the driving controller may determine whether to cause the own vehicle to continuously travel forward depending on whether an occupant boards another vehicle which is the obstacle when the recognizer recognizes that the obstacle and the oncoming vehicle are in the travel direction of the own vehicle and the recognizer recognizes that the oncoming vehicle is moving in the direction away from the own vehicle in the vehicle width direction.

(7) According to another aspect of the present invention, a vehicle control method is provided causing a computer: to recognize a surrounding situation of an own vehicle; to perform at least one of speed control and steering control of the own vehicle based on the recognized surrounding situation; and to cause the own vehicle to continuously travel forward when it is recognized that an obstacle and an oncoming vehicle are in a travel direction of the own vehicle and it is recognized that the oncoming vehicle is moving in a direction away from the own vehicle in a vehicle width direction.

(8) According to still another aspect of the present invention, a computer-readable non-transitory storage medium is provided storing a program causing a computer: to recognize a surrounding situation of an own vehicle; to perform at least one of speed control and steering control of the own vehicle based on the recognized surrounding situation; and to cause the own vehicle to continuously travel forward when it is recognized that an obstacle and an oncoming vehicle are in a travel direction of the own vehicle and it is recognized that the oncoming vehicle is moving in a direction away from the own vehicle in a vehicle width direction.

According to the aspects (1) to (8), it is possible to enable passing by an oncoming vehicle during automated driving to be performed more smoothly.

### BRIEF DESCRIPTION OF THE DRAWINGS

FIG. 1 is a diagram showing a configuration of a vehicle system in which a vehicle control device according to an embodiment is used.

FIG. 2 is a diagram showing a functional configuration of a first controller and a second controller.

FIG. 3 is a diagram showing an example of a scenario in which an own vehicle and an oncoming vehicle pass by one another.

FIG. 4 is a diagram showing an example of a target trajectory when a stopping vehicle is in a travel direction of the own vehicle.

FIG. 5 is a diagram showing an example of Mode 1 at the time of passing.

FIG. 6 is a diagram showing an example of Mode 2 at the time of passing.

FIG. 7 is a diagram showing an example of a target trajectory when a stopping vehicle and an oncoming vehicle are in a travel direction of the own vehicle.

FIG. 8 is a diagram showing an example of Mode 3 at the time of passing.

FIG. 9 is a flowchart showing an example of a process by an automated driving control device.

FIG. 10 is a flowchart showing the example of the process by the automated driving control device.

FIG. 11 is a diagram showing an example of a hardware configuration of the automated driving control device according to an embodiment.

### DESCRIPTION OF EMBODIMENTS

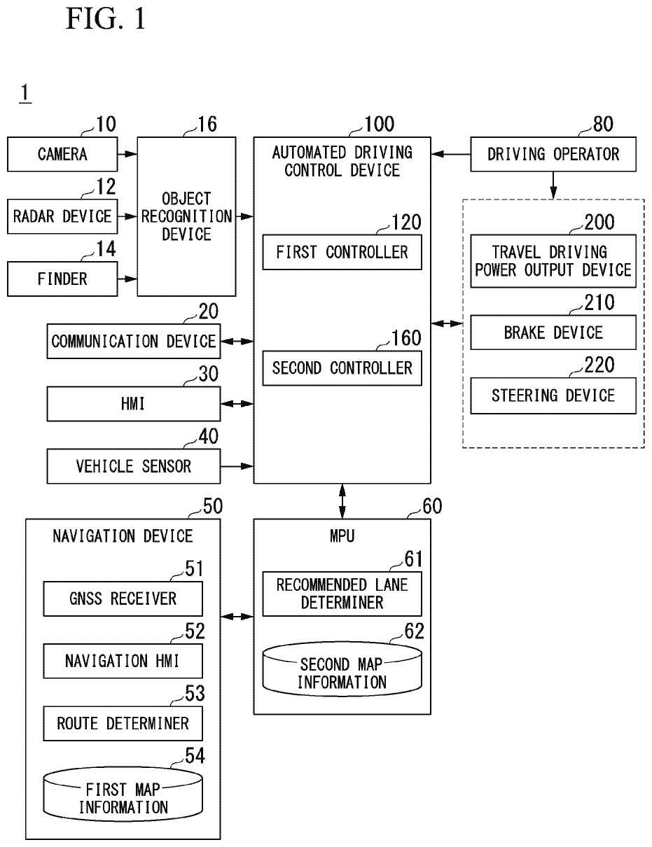

Hereinafter, an embodiment of a vehicle control device, a vehicle control method, and a storage medium according to the present invention will be described with reference to the drawings. Hereinafter, a case in which laws and regulations for left-hand traffic are applied will be described. However, when laws and regulations for right-hand traffic are applied, the left and right may be reversed. [Overall configuration] FIG. 1 is a diagram showing a configuration of a vehicle system 1 in which a vehicle control device according to an embodiment is used. A vehicle in which the vehicle system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, and a combination thereof. The electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving power output device 200, a brake device 210, and a steering device 220. The devices and units are connected to one another via a multiplex communication line such as a controller area network (CAN) communication line, a serial communication line, or a wireless communication network. The configuration shown in FIG. 1 is merely exemplary, part of the configuration may be omitted, and another configuration may be further added.

The camera 10 is, for example, a digital camera that uses a solid-state image sensor such as a charged coupled device (CCD) or a complementary metal oxide semiconductor (CMOS). The camera 10 is mounted on any portion of a vehicle in which the vehicle system 1 is mounted (hereinafter referred to as an own vehicle M). When the camera 10 images a front side, the camera 10 is mounted on an upper portion of a front windshield, a rear surface of a rearview mirror, and the like. For example, the camera 10 repeatedly images the surroundings of the own vehicle M periodically. The camera 10 may be a stereo camera.

The radar device 12 radiates radio waves such as millimeter waves to the surroundings of the own vehicle M and detects radio waves (reflected waves) reflected from an object to detect at least a position (a distance and an azimuth) of the object. The radar device 12 is mounted on any portion of the own vehicle M. The radar device 12 may detect a position and a speed of an object in conformity with a frequency modulated continuous wave (FM-CW) scheme.

The finder 14 is a light detection and ranging (LIDAR) finder. The finder 14 radiates light to the surroundings of the own vehicle M and measures scattered light. The finder 14 detects a distance to a target based on a time from light emission to light reception. The radiated light is, for example, pulsed laser light. The finder 14 is mounted on any portions of the own vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving control device 100. The object recognition device 16 may output detection results of the camera 10, the radar device 12, and the finder 14 to the automated driving control device 100 without any change. The object recognition device 16 may be excluded from the vehicle system 1.

The communication device 20 communicates with other vehicles around the own vehicle M using, for example, a cellular network, a Wi-Fi network, Bluetooth (registered trademark), dedicated short range communication (DSRC) or the like or communicates with a parking lot management device or various server devices via a wireless base station.

The HMI 30 presents various types of information to occupants of the own vehicle M and receives input operations by the occupants. For example, the HMI 30 includes various display devices, speakers, buzzers, touch panels, switches, and keys.

The vehicle sensor 40 includes a vehicle speed sensor that detects a speed of the own vehicle M, an acceleration sensor that detects acceleration, a yaw rate sensor that detects angular velocity around a vertical axis, and an azimuth sensor that detects a direction of the own vehicle M.

The navigation device 50 includes, for example, a global navigation satellite system (GNSS) receiver 51, a navigation HMI 52, and a route determiner 53. The navigation device 50 retains first map information 54 in a storage device such as a hard disk drive (HDD) or a flash memory. The GNSS receiver 51 specifies a position of the own vehicle M based on signals received from GNSS satellites. The position of the own vehicle M may be specified or complemented by an inertial navigation system (INS) using an output of the vehicle sensor 40. The navigation HMI 52 includes a display device, a speaker, a touch panel, and a key. The navigation HMI 52 may be partially or entirely common to the above-described HMI 30. The route determiner 53 determines, for example, a route from a position of the own vehicle M specified by the GNSS receiver 51 (or any input position) to a destination input by an occupant using the navigation HMI 52 (hereinafter referred to as a route on a map) with reference to the first map information 54. The first map information 54 is, for example, information in which a road shape is expressed by links indicating roads and nodes connected by the links. The first map information 54 may include curvatures of roads and point of interest (POI) information.

The route on the map is output to the MPU 60. The navigation device 50 may perform route guidance using the navigation HMI 52 based on the route on the map. The navigation device 50 may be realized by, for example, a function of a terminal device such as a smartphone or a tablet terminal possessed by an occupant. The navigation device 50 may transmit a present position and a destination to a navigation server via the communication device 20 to acquire the same route as the route on the map from the navigation server.

The MPU 60 includes, for example, a recommended lane determiner 61 and retains second map information 62 in a storage device such as an HDD or a flash memory. The recommended lane determiner 61 divides the route on the map provided from the navigation device 50 into a plurality of blocks (for example, divides the route in a vehicle movement direction for each 100 [m]) and determines a recommended lane for each block with reference to the second map information 62. The recommended lane determiner 61 determines in which lane the vehicle travels from the left.

When there is a branching location in the route on the map, the recommended lane determiner 61 determines a recommended lane so that the own vehicle M can travel in a reasonable route to move to a branching destination.

The second map information 62 is map information that has higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The second map information 62 may be updated frequently by communicating with another device using the communication device 20.

The driving operator 80 includes, for example, an accelerator pedal, a brake pedal, a shift lever, a steering wheel, a heteromorphic steering wheel, a joystick, and other operators. A sensor that detects whether there is an operation or an operation amount is mounted in the driving operator 80 and a detection result is output to the automated driving control device 100 or some or all of the travel driving power output device 200, the brake device 210, and the steering device 220.

The automated driving control device 100 includes, for example, a first controller 120 and a second controller 160. Each of the first controller 120 and the second controller 160 is realized, for example, by causing a hardware processor such as a central processing unit (CPU) to execute a program (software). Some or all of the constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The program may be stored in advance in a storage device (a storage device including a non-transitory storage medium) such as an HDD or a flash memory of the automated driving control device 100 or may be stored in a storage medium (a non-transitory storage medium) detachably mounted on a DVD, a CD-ROM, or the like so that the storage medium is mounted on a drive device to be installed on the HDD or the flash memory of the automated driving control device 100.

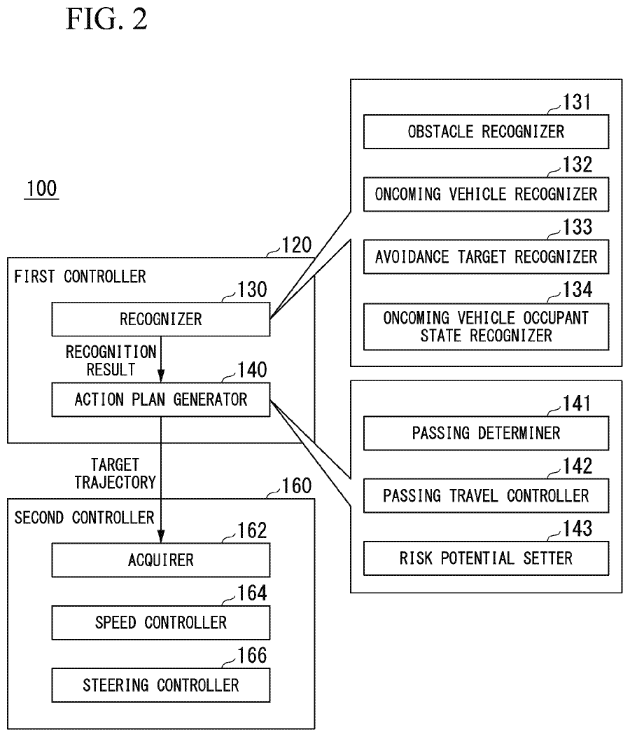

FIG. 2 is a diagram showing a functional configuration of the first controller 120 and the second controller 160. The first controller 120 includes, for example, a recognizer 130 and an action plan generator 140. The first controller 120 realizes, for example, a function by artificial intelligence (AI) and a function by a model given in advance in parallel. For example, a function of “recognizing an intersection” may be realized by performing recognition of an intersection by deep learning or the like and recognition based on a condition given in advance (a signal, a road sign, or the like which can be subjected to pattern matching) in parallel, scoring both the recognitions, and performing evaluation comprehensively. Thus, reliability of automated driving is guaranteed.

The recognizer 130 recognizes states such as positions, speeds, or acceleration of objects around the own vehicle M based on information input from the camera 10, the radar device 12, and the finder 14 via the object recognition device 16. For example, the positions of the objects are recognized as positions on the absolute coordinates in which a representative point (a center of gravity, a center of a driving shaft, or the like) of the own vehicle M is the origin and are used for control. The positions of the objects may be represented as representative points such as centers of gravity, corners, or the like of the objects or may be represented as expressed regions. A “state” of an object may include acceleration or jerk of the object or an “action state” (for example, whether a vehicle is changing a lane or is attempting to change the lane).

The recognizer 130 recognizes, for example, a lane in which the own vehicle M is traveling (a travel lane). For example, the recognizer 130 recognizes the travel lane by comparing patterns of road mark lines (for example, arrangement of solid lines and broken lines) obtained from the second map information 62 with patterns of road mark lines around the own vehicle M recognized from images captured by the camera 10. The recognizer 130 may recognize a travel lane by mainly recognizing runway boundaries (road boundaries) including road mark lines or shoulders, curbstones, median strips, and guardrails without being limited to road mark lines. In this recognition, the position of the own vehicle M acquired from the navigation device 50 or a process result by INS may be added. The recognizer 130 recognizes temporary stop lines, obstacles, red signals, toll gates, and other road events.

The recognizer 130 recognizes a position or a posture of the own vehicle M with respect to the travel lane when the recognizer 130 recognizes the travel lane. For example, the recognizer 130 may recognize a deviation from the middle of a lane of a standard point of the own vehicle M and an angle formed with a line extending along the middle of a lane in the travel direction of the own vehicle M as a relative position and posture of the own vehicle M to the travel lane. Instead of this, the recognizer 130 may recognize a position or the like of the standard point of the own vehicle M with respect to a side end portion (a road mark line or a road boundary) of any travel lane as the relative position of the own vehicle M to the travel lane.

The recognizer 130 includes, for example, an obstacle recognizer 131, an oncoming vehicle recognizer 132, an avoidance target recognizer 133, and an oncoming vehicle occupant state recognizer 134. The details thereof will be described later.

The action plan generator 140 generates a target trajectory along which the own vehicle M travels in future automatically (irrespective of an operation of a driver or the like) so that the own vehicle M is traveling along a recommended lane determined by the recommended lane determiner 61 and can handle a surrounding situation of the own vehicle M in principle. The target trajectory includes, for example, a speed component. For example, the target trajectory is expressed by arranging spots (trajectory points) at which the own vehicle M will arrive in sequence. The trajectory point is a spot at which the own vehicle M will arrive for each predetermined travel distance (for example, about several [m]) in a distance along a road. Apart from the trajectory points, target acceleration and a target speed are generated as parts of the target trajectory for each of predetermined sampling times (for example, about a decimal point of a second). The trajectory point may be a position at which the own vehicle M will arrive at the sampling time for each predetermined sampling time. In this case, information regarding the target acceleration or the target speed is expressed according to an interval between the trajectory points.

The action plan generator 140 may set an automated driving event when the target trajectory is generated. As the automated driving event, there are a constant speed traveling event, a low speed track traveling event, a lane changing event, a branching event, a joining event, a takeover event, and the like. The action plan generator 140 generates the target trajectory in accordance with an activated event.

The action plan generator 140 includes, for example, a passing determiner 141, a passing travel controller 142, and a risk potential setter 143. The details thereof will be described later.

The second controller 160 controls the travel driving power output device 200, the brake device 210, and the steering device 220 so that the own vehicle M passes along the target trajectory generated by the action plan generator 140 at a scheduled time.

The second controller 160 includes, for example, an acquirer 162, a speed controller 164, and a steering controller 166. The acquirer 162 acquires information regarding the target trajectory (trajectory points) generated by the action plan generator 140 and stores the information in a memory (not illustrated). The speed controller 164 controls the travel driving power output device 200 or the brake device 210 based on a speed element incidental to the target trajectory stored in the memory. The steering controller 166 controls the steering device 220 in accordance with a curve state of the target trajectory stored in the memory. Processes of the speed controller 164 and the steering controller 166 are realized, for example, by combining feed-forward control and feedback control. For example, the steering controller 166 performs the feed-forward control in accordance with a curvature of a road in front of the own vehicle M and the feedback control based on separation from the target trajectory in combination.

Referring back to FIG. 1, the travel driving power output device 200 outputs a travel driving force (torque) for traveling the vehicle to a driving wheel. The travel driving power output device 200 includes, for example, a combination of an internal combustion engine, an electric motor and a transmission, and an electronic controller (ECU) controlling these units. The ECU controls the foregoing configuration in accordance with information input from the second controller 160 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor.

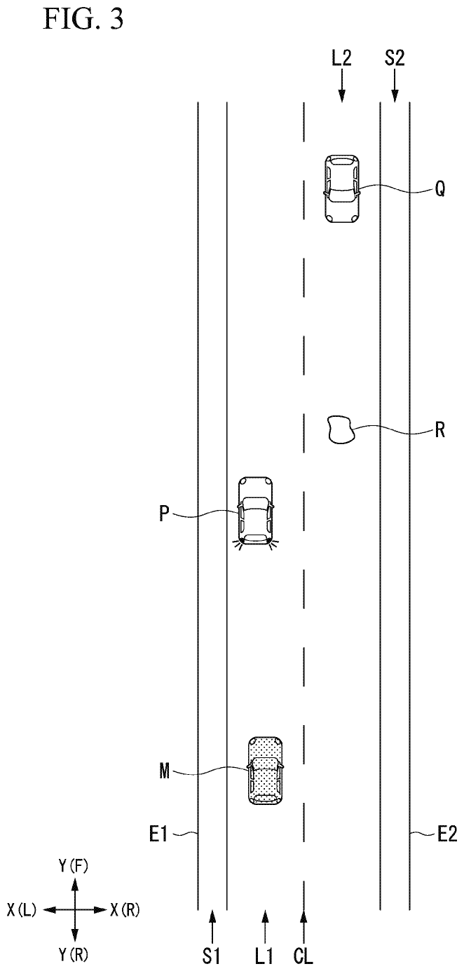

The electric motor works a force to, for example, a rack and pinion mechanism to change a direction of a steering wheel. The steering ECU drives the electric motor to change the direction of the steering wheel in accordance with information input from the second controller 160 or information input from the driving operator 80. [Function of recognizer 130] FIG. 3 is a diagram showing an example of a scenario in which the own vehicle M and an oncoming vehicle pass by one another. A travel lane L1 is a travel lane in which the own vehicle M is traveling and an oncoming lane L2 is an oncoming lane of the travel lane L1. The travel lane L1 and the oncoming lane L2 are adjacent with a center line CL interposed therebetween. The center line CL is a center line beyond which driving is not banned from passing. A road shoulder S1 is a road shoulder of the travel lane L1 and a road shoulder S2 is a road shoulder of the oncoming lane L2.

An outside (an end of a road) of the road shoulder S1 is a road mark line E1 and an outside (an end of a road) of the road shoulder S2 is a road mark line E2. A vehicle width direction is assumed to be X and a travel direction of each lane is assumed to be Y. A stopping vehicle P which has stopped on the travel lane L1 is in a travel direction Y(F) of the own vehicle M.

The stopping vehicle P is an example of an obstacle which is on the travel lane L1. An oncoming vehicle Q traveling in an opposite direction to the own vehicle M and an avoidance target R of the oncoming vehicle Q are on the oncoming lane L2 which is in the travel direction Y(F) of the own vehicle M. Examples of the avoidance target R include a falling object and an animal's carcass.

The obstacle recognizer 131 recognizes obstacles which are in front of the own vehicle M and on the travel lane L1. Examples of the obstacles include other vehicles which have stopped (for example, the stopping vehicle P), a bicycle which has stopped, a falling object, an animal's carcass, and a road cone disposed in a construction site or the like.

The obstacles may include a bicycle, a pedestrian, and the like which are traveling. Hereinafter, an example in which an obstacle is the stopping vehicle P will be described. For example, when the obstacle recognizer 131 recognizes that a tail lamp (a brake lamp, a hazard lamp, or the like) of another vehicle blinks, the obstacle recognizer 131 determines that an obstacle is a stopping vehicle. The obstacle recognizer 131 may recognize a speed of the obstacle and may determine that the obstacle has stopped when the recognized speed is equal to or less than a predetermined value.

When the recognized obstacle is a vehicle, the obstacle recognizer 131 may recognize that an occupant boards the vehicle. Here, the obstacle recognizer 131 may recognizes whether a boarding position of the occupant is on the side of a road shoulder or the side of a center line.

The oncoming vehicle recognizer 132 recognizes the oncoming vehicle Q which is traveling from the front of the own vehicle M in the opposite direction of the travel direction of the own vehicle M along the oncoming lane L2. The oncoming vehicle recognizer 132 recognizes that the oncoming vehicle Q is moving a direction away from the own vehicle M in a vehicle width direction X or recognizes a sign or the like indicated using a headlight. The details will be described below.

The avoidance target recognizer 133 recognizes an avoidance target R which is on the oncoming lane L2 and in the travel direction of the oncoming vehicle Q.

The oncoming vehicle occupant state recognizer 134 recognizes that a driver of the oncoming vehicle Q recognizes the own vehicle M. For example, when the oncoming vehicle occupant state recognizer 134 recognizes an occupant sitting on a driver seat among occupants of the oncoming vehicle Q as a driver and a time in which the eyes or the face of the recognized driver face the own vehicle M is greater than a predetermined length (several seconds), the oncoming vehicle occupant state recognizer 134 recognizes that the driver of the oncoming vehicle Q recognizes the own vehicle M. For example, the oncoming vehicle occupant state recognizer 134 acquires a facial image of an occupant in an image obtained by imaging the oncoming vehicle Q, estimates a direction of the visual line from a relative position or the like of the eyes in the acquired facial image, and recognizes whether the occupant sees the own vehicle M in the direction of the own vehicle M. The oncoming vehicle occupant state recognizer 134 may recognize that the driver of the oncoming vehicle Q recognizes the own vehicle M when the oncoming vehicle occupant state recognizer 134 recognizes a sign such as passing indicated using a headlight by the oncoming vehicle Q.

An obstacle recognized by the obstacle recognizer 131 is an avoidance target of the own vehicle M which is on the travel lane L1 and an avoidance target recognized by the avoidance target recognizer 133 is an obstacle of the oncoming vehicle Q which is on the oncoming lane L2. Accordingly, the obstacle recognizer 131 and the avoidance target recognizer 133 can recognize an obstacle or an avoidance target using the same scheme. For example, the obstacle recognizer 131 and the avoidance target recognizer 133 recognize an object located on a road as an obstacle or an avoidance target except for text, signs, or the like printed on the road.

### [Function of Action Plan Generator 140]

The passing determiner 141 determines a mode at the time of passing an obstacle based on a recognition result by the obstacle recognizer 131, the oncoming vehicle recognizer 132, or the avoidance target recognizer 133. The mode at the time of passing an obstacle includes Modes 1 to 3 to be described below. In accordance with a mode determined by the passing determiner 141, the passing travel controller 142 performs passing travel control of the own vehicle M.

The passing determiner 141 may determine whether passing is possible before a mode at the time of passing is determined. When it is determined that the passing is possible, the passing determiner 141 determines a mode at the time of passing. For example, the passing determiner 141 determines whether the own vehicle M will travel beyond the center line CL at the time of passing the stopping vehicle P from the right side based on a recognition result of the obstacle recognizer 131 (the length of the travel lane L1 in the vehicle width direction X and the length of the stopping vehicle P in the vehicle width direction X) and the length of the own vehicle M in the vehicle width direction X. When the own vehicle M will not travel beyond the center line CL at the time of passing the stopping vehicle P from the right side, the passing determiner 141 determines that the passing is possible in a state in which there is the oncoming vehicle.

Conversely, when the own vehicle will travel beyond the center line CL at the time of passing the stopping vehicle P from the right side, the passing determiner 141 determines whether the center line CL is a center line beyond which driving is not banned from passing based on a shape or color of the center line CL. When the center line CL is the center line beyond which driving is not banned from passing, the passing determiner 141 determines that passing is possible in a state in which there is no oncoming vehicle. Conversely, when the center line CL is a center line beyond which driving is banned from passing, the passing determiner 141 determines that no passing is possible in any case.

When the recognizer 130 recognizes that an obstacle is on the travel lane L1, the passing travel controller 142 performs passing travel control in which an obstacle is passed to travel. As a condition that the passing travel control is performed, a condition that the passing determiner 141 determines that passing is possible may be included. Hereinafter, the example in which an obstacle has stopped has been described. However, the same applies even when an obstacle moving in the same direction as a travel direction of the own vehicle M is passed or when an obstacle moving an opposite direction to a travel direction of the own vehicle M is avoided and passed.

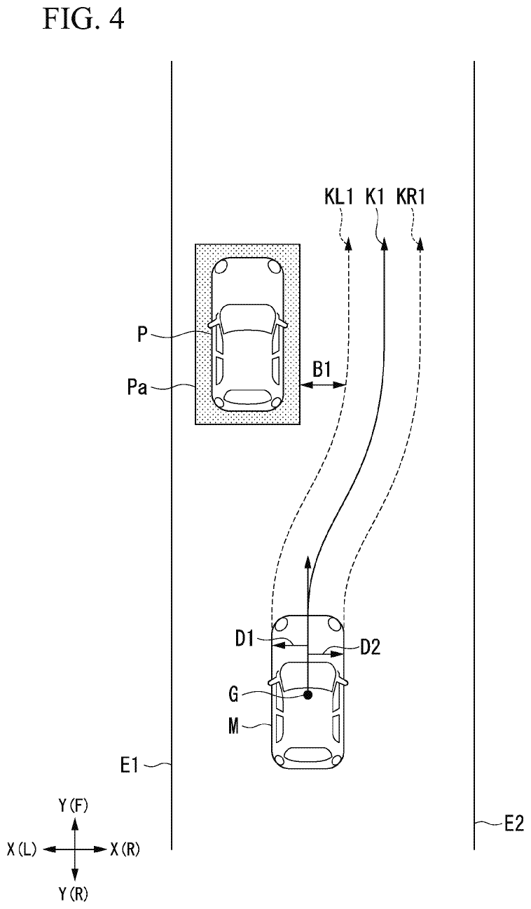

The passing travel controller 142 generates a target trajectory used for the own vehicle M to pass an obstacle based on the size of an object when the recognizer 130 recognizes that the obstacle is on the travel lane L1. FIG. 4 is a diagram showing an example of a target trajectory when the stopping vehicle P is in a travel direction of the own vehicle M. In the example of FIG. 4, it is assumed that the stopping vehicle P is in a travel direction of the own vehicle M on the travel lane L1 alone. The stopping vehicle P alone is, for example, a stopping vehicle which is distant from another stopping vehicle by a predetermined distance (for example, about several [m] or more). In the example of FIG. 4, the own vehicle M is assumed to perform passing driving to pass the right side of the stopping vehicle P.

For example, when the recognizer 130 recognizes the stopping vehicle P which is in the travel direction of the own vehicle M, the passing travel controller 142 sets a contact-estimated region Pa in which it is estimated that there is a likelihood of contact with the stopping vehicle P based on contour information of the stopping vehicle P. The contour information is, for example, information indicating contour of the stopping vehicle P recognized by the obstacle recognizer 131. The passing travel controller 142 generates a target trajectory K1 for passing the stopping vehicle P without contact with the set contact-estimated region Pa.

First, the passing travel controller 142 provisionally sets the target trajectory K1 for passing a center (for example, a center of gravity G) of the own vehicle M and generates a left offset trajectory KL1 in which the provisionally set target trajectory K1 is offset by a distance D1 to the left end of the own vehicle M in the horizontal direction (a road width direction: the X direction in the drawing). Then, when the stopping vehicle P is passed from the right side, the passing travel controller 142 generates the target trajectory K1 so that a distance between the left offset trajectory KL1 and the contact-estimated region Pa is equal to or greater than a minimum interval B1.

The passing travel controller 142 may generate a right offset trajectory KR1 in which the provisionally set target trajectory K1 is offset by a distance D2 to the right vehicle wheels of the own vehicle M in the horizontal direction in addition to the left offset trajectory KL1. The distances D1 and D2 may be the same value or may be different values. The passing travel controller 142 generates the target trajectory K1 so that a distance between the left offset trajectory KL1 and the contact-estimated region Pa is equal to or greater than the minimum interval B1 and the right offset trajectory KR1 is not beyond the road mark line E2. Thus, the own vehicle M can pass the stopping vehicle P without traveling out of a road.

The risk potential setter 143 generates a map (not illustrated) indicating a region in which the own vehicle M is prohibited from traveling or a probability from the present to the future of traffic participants (pedestrians or other vehicles) being present based on a recognition result of the recognizer 130 and calculates a risk potential by searching the map in accordance with the target trajectory. The risk potential is a value indicating a region in which there is a likelihood (probability) of traffic participants being nearby in the travel direction of the own vehicle M and a region in which there is a likelihood (probability) of an area in which the own vehicle M is banned from traveling, or the like from the present to the future being present. The risk potential is calculated as 0 in a region in which an existence probability of traffic participants is low and is calculated as an increasing positive value as the existence probability becomes higher.

### (Mode 1 at Time of Passing)

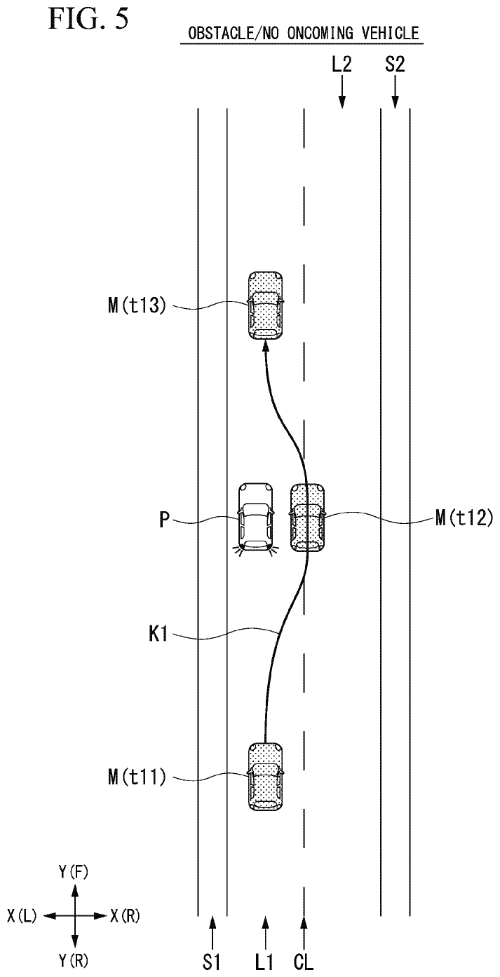

FIG. 5 is a diagram showing an example of Mode 1 at the time of passing. First, the obstacle recognizer 131 recognizes that the stopping vehicle P is on the travel lane L1 and the oncoming vehicle recognizer 132 recognizes that the oncoming vehicle Q is not traveling on the oncoming lane L2. In this case, the passing determiner 141 determines Mode 1 as the mode at the time of passing the obstacle P. Mode 1 is a mode in which the own vehicle M continuously travels forward and passes the obstacle without stopping the own vehicle M behind the stopping vehicle P. For example, the passing travel controller 142 generates the above-described target trajectory K1 and causes the own vehicle to travel along the target trajectory K1. Specifically, the own vehicle M generates the target trajectory K1 at time al. At time t12, the own vehicle M travels beyond the center line CL and passes the right side of the stopping vehicle P. At time t13, the own vehicle M returns to the travel lane L1 and travels along the lane.

### (Mode 2 at Time of Passing)

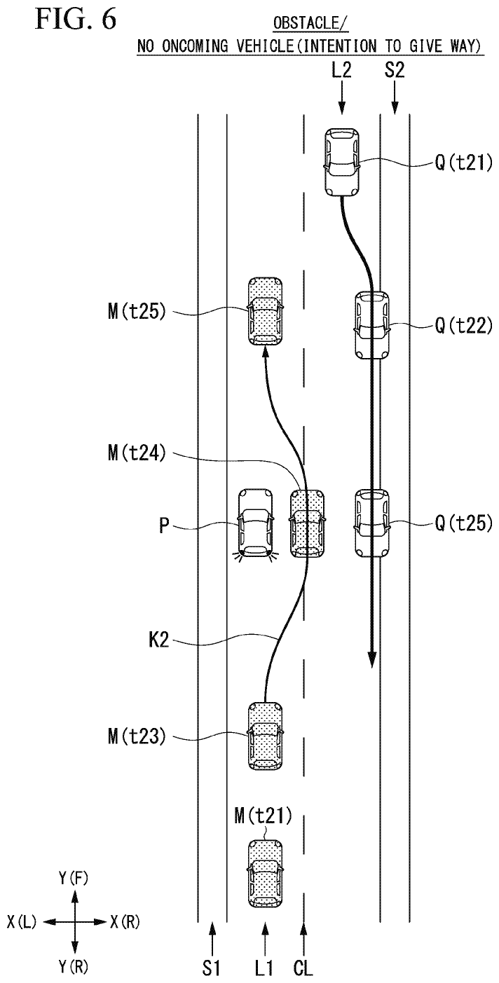

FIG. 6 is a diagram showing an example of Mode 2 at the time of passing. First, the obstacle recognizer 131 recognizes that the stopping vehicle P is on the travel lane L1 and the oncoming vehicle recognizer 132 recognizes that the oncoming vehicle Q is traveling on the oncoming lane L2. In this case, the passing determiner 141 determines whether the oncoming vehicle Q intends to give way to the own vehicle M. For example, when the recognizer 130 recognizes that the oncoming vehicle Q performs an action to give way to the own vehicle M, the passing determiner 141 determines that the oncoming vehicle Q intends to give way to the own vehicle M.

When the passing determiner 141 determines that the oncoming vehicle Q intends to give way to the own vehicle M, the passing determiner 141 determines Mode M2 as the mode at the time of passing the obstacle. Mode 2 is a mode in which the own vehicle M continuously travels forward and passes the obstacle while checking a positional relation with the oncoming vehicle Q without stopping the own vehicle M behind the stopping vehicle P. For example, the passing travel controller 142 generates the target trajectory K2 to be described below and causes the own vehicle M to travel along the target trajectory K2. Specifically, at time t21, the own vehicle M recognizes the oncoming vehicle Q. Thereafter, at time t22, the own vehicle M recognizes that the oncoming vehicle Q is moving in a direction away from the own vehicle M in the vehicle width direction X. Then, at time t23, the own vehicle M generates the target trajectory K2. The target trajectory K2 is a trajectory in which the own vehicle M enters the oncoming lane L2 from the travel lane L1 beyond the center line CL and advances while avoiding the stopping vehicle P. At time t24, the own vehicle M travels beyond the center line CL and passes the right side of the stopping vehicle P. At time t25, the own vehicle M returns to the travel lane L1 to travel along the lane and the oncoming vehicle Q passes by the stopping vehicle P.

An “action” to give way to the own vehicle M″ includes, for example, movement of the oncoming vehicle Q in a direction away from the own vehicle M in the vehicle width direction X (for example, the direction X(R)). Here, the passing determiner 141 may determine whether a movement amount by which the oncoming vehicle Q moves in the direction away from the own vehicle M is equal to or greater than a first threshold. When the movement amount is equal to or greater than the first threshold, the passing determiner 141 determines that the oncoming vehicle Q intends to give way to the own vehicle M. Conversely, when the movement amount is less than the first threshold, the passing determiner 141 determines that the oncoming vehicle Q has no intention to give to way to the own vehicle M.

The present invention is not limited thereto and the “action” to give way to the own vehicle M″ includes a case in which the oncoming vehicle Q is moving in a direction away from the own vehicle M in the vehicle width direction X and it is recognized that a speed of the oncoming vehicle Q is decelerating (for example, the speed of the oncoming vehicle Q is equal to or less than a second threshold) or a case in which the oncoming vehicle Q is moving in a direction away from the own vehicle M in the vehicle width direction X and a sign indicating a permission to travel (allowing the own vehicle M to go ahead) by the oncoming vehicle Q using a headlight is recognized. The sign indicating the permission to travel using the headlight includes, for example, lowering the headlight, turning off the headlight, and passing.

The “action to give way to the own vehicle M” may include a case in which the oncoming vehicle Q is moving in a direction away from the own vehicle M in the vehicle width direction X and it is recognized that the driver of the oncoming vehicle Q recognizes the own vehicle M or a case in which the oncoming vehicle Q is moving in a direction away from the own vehicle M in the vehicle width direction X and it is recognized that an obstacle or another avoidance target R is not near the oncoming vehicle Q.

Even when it is determined that the oncoming vehicle Q intends to give way to the own vehicle M, the passing determiner 141 may determine whether to cause the own vehicle M to continuously travel forward depending on whether an occupant boards the stopping vehicle P. For example, when the obstacle recognizer 131 recognizes that the occupant boards the stopping vehicle P or when it is recognized that an occupant boards on a seat on the side of the center line of the stopping vehicle P, the passing determiner 141 determines that the own vehicle M is not allowed to continuously travel forward. Conversely, when the obstacle recognizer 131 recognizes that an occupant does not board the stopping vehicle P or when it is recognized that an occupant does not board on a seat on the side of the center line despite the recognition of the occupant in the stopping vehicle P, the passing determiner 141 determines that the own vehicle M is caused to continuously travel forward.

Conversely, when it is determined that the oncoming vehicle Q has no intention to give way to the own vehicle M, the passing determiner 141 determines Mode 3 as the mode at the time of passing the stopping vehicle P. Although the details will be described below, in Mode 2 at the time of passing, travel control in which the own vehicle M passes the stopping vehicle P while continuously traveling forward is performed. In Mode 3 at the time of passing, travel control in which the own vehicle M passes the stopping vehicle P after temporarily stopping without continuously travel forward is performed. In Modes 2 and 3 at the time of passing the stopping vehicle P, the own vehicle M may travel beyond the center line CL and pass the stopping vehicle P. When the own vehicle M can pass the stopping vehicle P and travel without traveling beyond the center line CL, the own vehicle M may pass the stopping vehicle P without traveling beyond the center line CL.

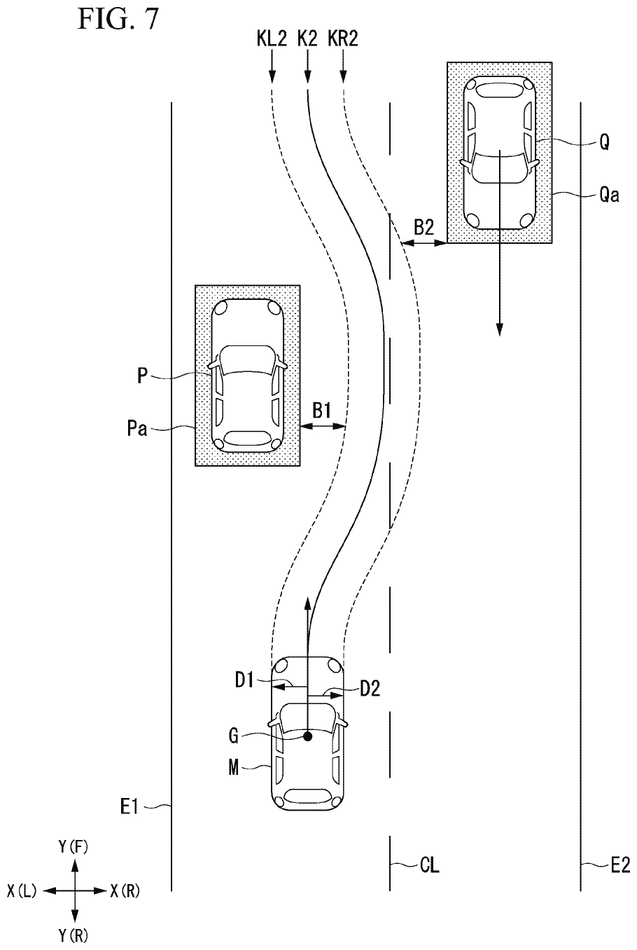

FIG. 7 is a diagram showing an example of a target trajectory when the stopping vehicle P and the oncoming vehicle Q are in a travel direction of the own vehicle M. In the example of FIG. 7, it is assumed that the stopping vehicle P is alone in a travel direction of the own vehicle M on the travel lane L1 and the oncoming vehicle Q is alone in a travel direction of the own vehicle M on the oncoming lane L2. The oncoming vehicle Q alone is, for example, an oncoming vehicle which is distant from another oncoming vehicle by a predetermined distance (for example, several [m] or more). In the example of FIG. 7, the own vehicle M is assumed to perform passing driving to pass the right side of the stopping vehicle P earlier than the oncoming vehicle Q.

For example, when the recognizer 130 recognizes the stopping vehicle P which is in the travel direction of the own vehicle M, the passing travel controller 142 sets a contact-estimated region Pa in which it is estimated that there is a likelihood of contact with the stopping vehicle P based on contour information of the stopping vehicle P. When the recognizer 130 recognizes that the oncoming vehicle Q is in the travel direction of the own vehicle M, the passing travel controller 142 sets a contact-estimated region Qa in which it is estimated that there is a likelihood of contact with the oncoming vehicle Q based on contour information of the oncoming vehicle Q. When the oncoming vehicle Q is moving, the passing travel controller 142 estimates a position of the oncoming vehicle Q at a time point at which the own vehicle M passes by the oncoming vehicle Q based on a movement speed of the oncoming vehicle Q and sets the contact-estimated region Qa corresponding to the estimated position.

The passing travel controller 142 passes the stopping vehicle P without contact with the set contact-estimated region Pa and subsequently generates the target trajectory K2 for passing by the oncoming vehicle Q without contact with the set contact-estimated region Qa.

First, the passing travel controller 142 provisionally sets the target trajectory K2 for passing a center (for example, a center of gravity G) of the own vehicle M and generates a left offset trajectory KL2 in which the provisionally set target trajectory K2 is offset by the distance D1 to the left end of the own vehicle M in the horizontal direction (a road width direction: the X direction in the drawing). The passing travel controller 142 generates a right offset trajectory KR2 in which the provisionally set target trajectory K2 is offset by the distance D2 to the right vehicle wheels of the own vehicle M in the horizontal direction in addition to the left offset trajectory KL2. Then, the passing travel controller 142 generates the target trajectory K2 so that a distance between the left offset trajectory KL2 and the contact-estimated region Pa is equal to or greater than the minimum interval B1 and a distance between the right offset trajectory KR2 and the contact-estimated region Qa is equal to or greater than a minimum interval B2. Thus, the own vehicle M can pass the stopping vehicle P so that the minimum intervals to the stopping vehicle P and the oncoming vehicle Q are equal to or greater than B1 and B2 and pass by the oncoming vehicle Q. The minimum intervals B1 and B2 may be the same value or may be different values.

### (Mode 3 at Time of Passing)

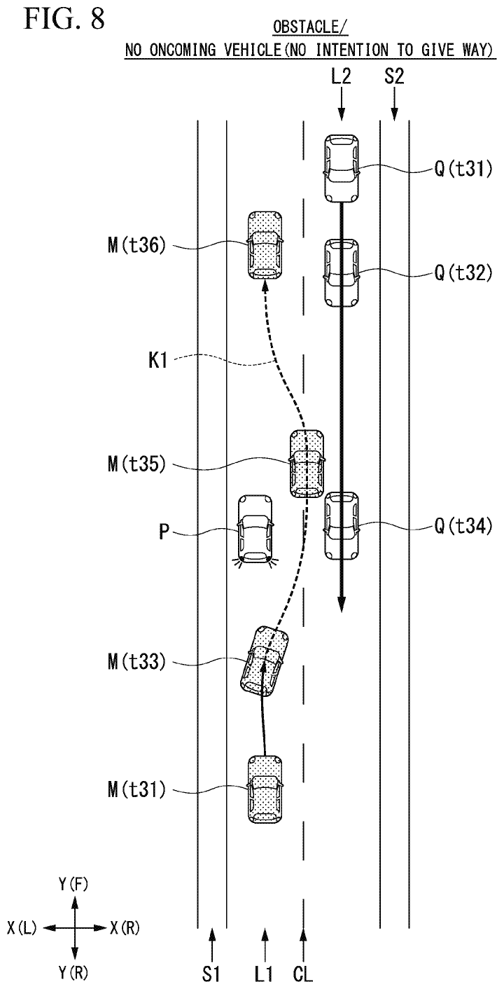

FIG. 8 is a diagram showing an example of Mode 3 at the time of passing. First, the obstacle recognizer 131 recognizes that the stopping vehicle P is on the travel lane L1 and the oncoming vehicle recognizer 132 recognizes that the oncoming vehicle Q is traveling on the oncoming lane L2. In this case, the passing determiner 141 determines whether the oncoming vehicle Q intends to give way to the own vehicle M. In the example of FIG. 8, it is assumed that the oncoming vehicle Q is coming straightly in the middle of the oncoming lane L2 and does not perform an action to avoid to the side of the road shoulder S2. Therefore, the passing determiner 141 determines that the oncoming vehicle Q has no intention to give way to the own vehicle M.

When the passing determiner 141 determines that the oncoming vehicle Q has no intention to give way to the own vehicle M, the passing determiner 141 determines Mode 3 as the mode at the time of passing the obstacle. Mode 3 is a mode in which the own vehicle M stops behind the stopping vehicle P and passes the stopping vehicle P after the oncoming vehicle Q passes. Specifically, at time t31, the own vehicle M recognizes the oncoming vehicle Q.

Thereafter, at time t32, the own vehicle M recognizes that the oncoming vehicle Q is not moving in the direction away from the own vehicle M in the vehicle width direction X. Then, at time t33, the own vehicle M generates the target trajectory K1, travels along the target trajectory K1, and temporarily stops before traveling beyond the center line CL. At time t34, the oncoming vehicle Q passes by the stopping vehicle P. Thereafter, at time t35, the own vehicle M travels beyond the center line CL and passes the right side of the stopping vehicle P. At time t36, the own vehicle M returns to the travel lane L1 and travels along the lane.

### [Flowchart]

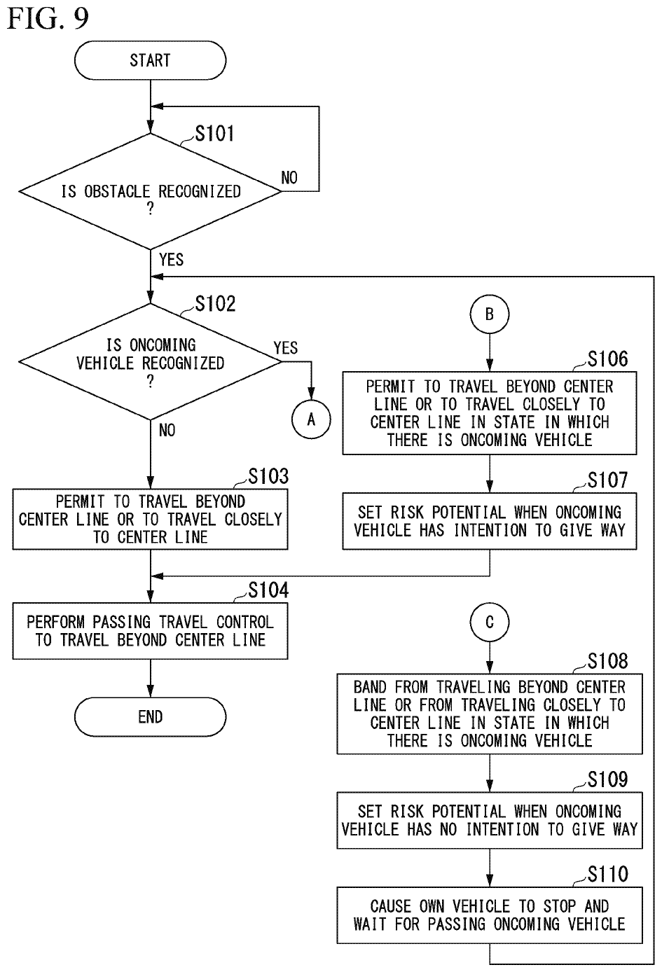

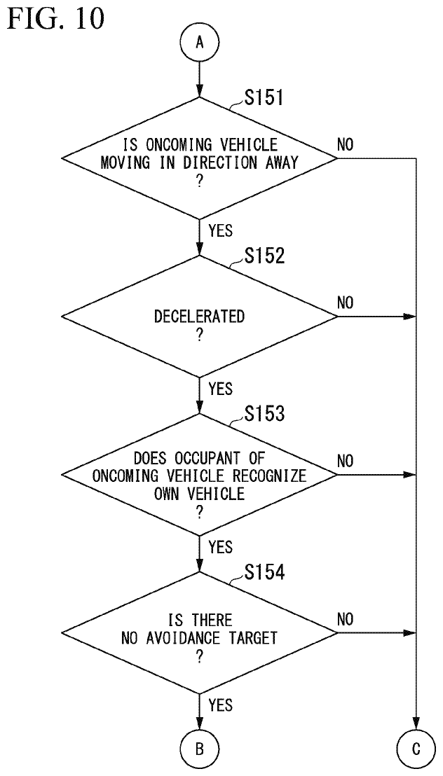

FIGS. 9 and 10 are flowcharts showing an example of a process by the automated driving control device 100. First, the obstacle recognizer 131 determines whether to recognize that an obstacle is on the travel lane L1 (step S101). When it is recognized that the obstacle is on the travel lane L1, the oncoming vehicle recognizer 132 determines whether to recognize that an oncoming vehicle is on the oncoming lane L2 (step S102). When it is not recognized that the oncoming vehicle is on the oncoming lane L2, the passing determiner 141 determines Mode 1 as a passing method at the time of passing the obstacle. Then, the passing travel controller 142 permits to travel beyond the center line CL (or passes closely to the center line CL) (step S103), generates the target trajectory K1 and performs passing travel control in which the own vehicle M travels beyond the center line (step S104). The passing travel controller 142 determines whether the own vehicle M can travel without traveling beyond the center line CL based on a vehicle width size (that is, a space in which the own vehicle M can travel near the obstacle) in which the travel lane L1 is unoccupied. Then, when the own vehicle M cannot travel without traveling beyond the center line CL while avoiding the obstacle, the passing travel controller 142 permits to travel beyond the center line CL. When the own vehicle M can travel without traveling beyond the center line CL while avoiding the obstacle, the passing travel controller 142 permits to pass closely to the center line CL.

Conversely, when it is recognized in step S102 that the oncoming vehicle is on the oncoming lane L2, the flowchart transitions to FIG. 10 and the passing determiner 141 determines whether the recognizer 130 recognizes that the oncoming vehicle Q is moving in the direction away from the own vehicle M in the vehicle width direction X (step S151). When the recognizer 130 recognizes that the oncoming vehicle Q is moving in the direction away from the own vehicle M in the vehicle width direction X, the passing determiner 141 determines whether the recognizer 130 recognizes that the oncoming vehicle Q is decelerating (step S152). When the recognizer 130 recognizes that the oncoming vehicle Q is decelerating, the passing determiner 141 determines whether the recognizer 130 recognizes that an occupant of the oncoming vehicle Q recognizes the own vehicle M (step S153). When the recognizer 130 recognizes that the occupant of the oncoming vehicle Q recognizes the own vehicle M, the passing determiner 141 determines whether or not a recognized result by the recognizer 130 indicating that the avoidance target R is not near the oncoming vehicle Q (step S154).

When the recognizer 130 recognizes in step S154 that the recognizer 130 recognizes that the avoidance target R is not near the oncoming vehicle Q, the process returns to FIG. 9 and the passing determiner 141 determines Mode 2 as the passing method at the time of passing the obstacle. Then, the passing travel controller 142 permits to travel beyond the center line CL (or pass closely to the center line CL) in the state in which there is the oncoming vehicle Q (step S106). The risk potential setter 143 sets a risk potential when the oncoming vehicle intends to give way (step S107). Then, the passing travel controller 142 generates the target trajectory K2 and performs the passing travel control to travel beyond the center line (step S104).

Conversely, when the recognizer 130 does not recognize in step S151 that the oncoming vehicle Q is moving in the direction away from the own vehicle M in the vehicle width direction X, when the recognizer 130 does not recognize in step S152 that the oncoming vehicle Q is decelerating, when the recognizer 130 does not recognize in step S153 that the occupant of the oncoming vehicle Q recognizes the own vehicle M, or when the recognizer 130 does not recognize in step S154 that the avoidance target R is not near the oncoming vehicle Q, the passing determiner 141 determines Mode 3 as the passing method at the time of passing the obstacle. Then, the passing travel controller 142 bans the own vehicle M from traveling beyond the center line CL (or passing closely the center line CL) in the state in which there is the oncoming vehicle Q (step S108). The risk potential setter 143 sets a risk potential when the oncoming vehicle has no intention to give way (step S109). Then, the passing travel controller 142 generates the target trajectory K1, causes the own vehicle M to travel along the target trajectory K1, and causes the own vehicle M to temporarily stop before traveling beyond the center line CL. After the oncoming vehicle Q passes by the own vehicle M, the passing travel controller 142 causes the own vehicle M to travel again along the target trajectory K1 (step S110).

The risk potential corresponding to the oncoming vehicle Q when the oncoming vehicle intends to give way is lower than the risk potential when the oncoming vehicle has no intention to give way.

In the flowchart, the example in which when the positive results are determined in all of steps S151 to S154, the passing travel controller 142 permits the own vehicle to travel beyond the center line CL in the state where there is the oncoming vehicle Q has been described, but the present invention is not limited thereto. For example, when the positive result is determined in at least one of steps S151 to S154, the passing travel controller 142 may permit the own vehicle to travel beyond the center line CL in the state in which there is the oncoming vehicle Q and may cause the own vehicle M to continuously travel forward. When the negative result is determined in at least one of steps S151 to S154, the passing travel controller 142 may ban the own vehicle M from traveling beyond the center line CL in the state in which there is the oncoming vehicle Q and may cause the own vehicle M to stop traveling forward.

For example, when the recognizer 130 recognizes that the stopping vehicle P and the oncoming vehicle Q are in the travel direction of the own vehicle M, the recognizer 130 recognizes that the oncoming vehicle Q is moving in the direction away from the own vehicle M in the vehicle width direction X, and the recognizer 130 recognizes that the oncoming vehicle Q is decelerating, the automated driving control device 100 causes the own vehicle M to continuously travel forward. In other words, when the recognizer 130 recognizes that the stopping vehicle P and the oncoming vehicle Q are in the travel direction of the own vehicle M, the recognizer 130 recognizes that the oncoming vehicle Q is moving in the direction away from the own vehicle M in the vehicle width direction X, and the recognizer 130 does not recognize that the oncoming vehicle Q is decelerating, the automated driving control device 100 causes the own vehicle M not to continuously travel forward.

When the recognizer 130 recognizes that the stopping vehicle P and the oncoming vehicle Q are in the travel direction of the own vehicle M, the recognizer 130 recognizes that the oncoming vehicle Q is moving in the direction away from the own vehicle M in the vehicle width direction X, and the recognizer 130 recognizes that the driver of the oncoming vehicle Q recognizes the own vehicle M, the automated driving control device 100 causes the own vehicle M to continuously travel forward. In other words, when the recognizer 130 recognizes that the stopping vehicle P and the oncoming vehicle Q are in the travel direction of the own vehicle M, the recognizer 130 recognizes that the oncoming vehicle Q is moving in the direction away from the own vehicle M in the vehicle width direction X, and the recognizer 130 does not recognize that the driver of the oncoming vehicle Q recognizes the own vehicle M, the automated driving control device 100 causes the own vehicle M not to continuously travel forward.

As described above, when the recognizer 130 recognizes that the stopping vehicle P and the oncoming vehicle Q are in the travel direction of the own vehicle M, the recognizer 130 recognizes that the oncoming vehicle Q is moving in the direction away from the own vehicle M in the vehicle width direction X, and the recognizer 130 recognizes that the avoidance target R is not near the oncoming vehicle Q, the automated driving control device 100 causes the own vehicle M to continuously travel forward. In other words, when the recognizer 130 recognizes that the stopping vehicle P and the oncoming vehicle Q are in the travel direction of the own vehicle M, the recognizer 130 recognizes that the oncoming vehicle Q is moving in the direction away from the own vehicle M in the vehicle width direction X, and the recognizer 130 recognizes that the avoidance target R is near the oncoming vehicle Q, the automated driving control device 100 causes the own vehicle M not to continuously travel forward.

### [Hardware Configuration]

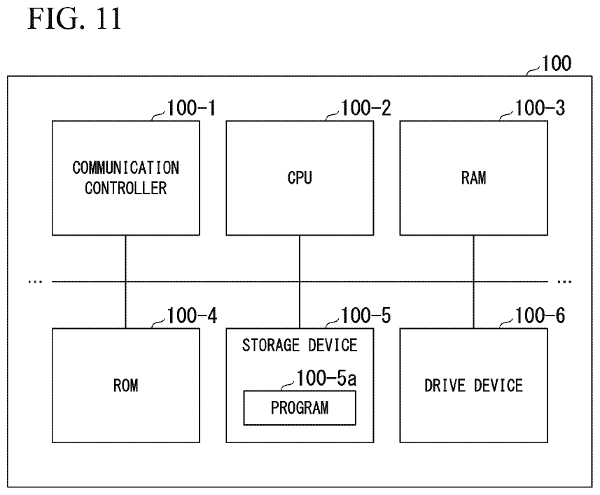

FIG. 11 is a diagram showing an example of a hardware configuration of the automated driving control device 100 according to an embodiment. As illustrated, the automated driving control device 100 is configured such that a communication controller 100-1, a CPU 100-2, a random access memory (RAM) 100-3 that is used as a working memory, a read-only memory (ROM) 100-4 that stores a boot program or the like, a storage device 100-5 such as a flash memory or a hard disk drive (HDD), a drive device 100-6, and the like are connected to each other via an internal bus or a dedicated communication line. The communication controller 100-1 performs communication with constituent element other than the automated driving control device 100. The storage device 100-5 stores a program 100-5a that is executed by the CPU 100-2. The program is loaded on the RAM 100-3 by a direct memory access (DMA) controller (not illustrated) to be executed by the CPU 100-2. Thus, some or all of the first controller 120 and the second controller 160 are realized.

The above-described embodiment can be expressed as a vehicle control device including a storage device that stores a program and a hardware processor, the vehicle control device causing the hardware processor to execute the program stored in the storage device, to recognize a surrounding situation of an own vehicle; to perform at least one of speed control and steering control of the own vehicle based on the recognized surrounding situation; and to cause the own vehicle to continuously travel forward when a recognizer recognizes that an obstacle and an oncoming vehicle are in a travel direction of the own vehicle and the recognizer recognizes that the oncoming vehicle is moving in a direction away from the own vehicle in a vehicle width direction.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognizer configured to recognize a surrounding situation of an own vehicle; and
a driving controller configured to perform at least one of speed control and steering control of the own vehicle based on the surrounding situation recognized by the recognizer,
wherein the driving controller causes the own vehicle to continuously travel forward when the recognizer recognizes that an obstacle and an oncoming vehicle are in a travel direction of the own vehicle and the recognizer recognizes that the oncoming vehicle is moving in a direction away from the own vehicle in a vehicle width direction.

2. The vehicle control device according to claim 1, wherein the driving controller causes the own vehicle to travel forward so that the own vehicle enters the oncoming lane to avoid the obstacle when the recognizer recognizes that the obstacle and the oncoming vehicle are in the travel direction of the own vehicle and the recognizer recognizes that the oncoming vehicle is moving in the direction away from the own vehicle in the vehicle width direction.

3. The vehicle control device according to claim 1, wherein the driving controller causes the own vehicle to continuously travel forward when the recognizer recognizes that the obstacle and the oncoming vehicle are in the travel direction of the own vehicle, the recognizer recognizes that the oncoming vehicle is moving in the direction away from the own vehicle in the vehicle width direction, and the recognizer recognizes that the oncoming vehicle is decelerating.

4. The vehicle control device according to any one of claim 1, wherein the driving controller causes the own vehicle to continuously travel forward when the recognizer recognizes that the obstacle and the oncoming vehicle are in the travel direction of the own vehicle, the recognizer recognizes that the oncoming vehicle is moving in the direction away from the own vehicle in the vehicle width direction, and the recognizer recognizes that a driver of the oncoming vehicle recognizes the own vehicle.

5. The vehicle control device according to any one of claim 1, wherein the driving controller causes the own vehicle to continuously travel forward when the recognizer recognizes that the obstacle and the oncoming vehicle are in the travel direction of the own vehicle, the recognizer recognizes that the oncoming vehicle is moving in the direction away from the own vehicle in the vehicle width direction, and the recognizer recognizes that the obstacle and another avoidance target are not near the oncoming vehicle.

6. The vehicle control device according to any one of claim 1, wherein the driving controller determines whether to cause the own vehicle to continuously travel forward depending on whether an occupant boards another vehicle which is the obstacle when the recognizer recognizes that the obstacle and the oncoming vehicle are in the travel direction of the own vehicle and the recognizer recognizes that the oncoming vehicle is moving in the direction away from the own vehicle in the vehicle width direction.

7. A vehicle control method causing a computer:
to recognize a surrounding situation of an own vehicle;
to perform at least one of speed control and steering control of the own vehicle based on the recognized surrounding situation; and
to cause the own vehicle to continuously travel forward when it is recognized that an obstacle and an oncoming vehicle are in a travel direction of the own vehicle and it is recognized that the oncoming vehicle is moving in a direction away from the own vehicle in a vehicle width direction.

8. A computer-readable non-transitory storage medium that stores a program causing a computer:
to recognize a surrounding situation of an own vehicle;
to perform at least one of speed control and steering control of the own vehicle based on the recognized surrounding situation; and
to cause the own vehicle to continuously travel forward when it is recognized that an obstacle and an oncoming vehicle are in a travel direction of the own vehicle and it is recognized that the oncoming vehicle is moving in a direction away from the own vehicle in a vehicle width direction.
